(19) United States
(12) Patent Application Publication
(10) Pub. No.: US 2011/0044044 A1
(43) Pub. Date: Feb. 24, 2011

(54) LAMP AND A PROCESS FOR PRODUCING A LAMP

(75) Inventors: Balu Jeganathan, South Yarra (AU); John Albert Montagnat, East Ringwood (AU)

Correspondence Address: KNOBBE MARTENS OLSON & BEAR LLP, 2040 MAIN STREET, FOURTEENTH FLOOR, IRVINE, CA, 92614, US

(73) Assignee: LEDNIUM TECHNOLOGY PTY LIMITED, New South Wales (AU)

(21) Appl. No.: 12/849,762

(22) Filed: Aug. 3, 2010

Related U.S. Application Data
(62) Division of application No. 10/548,498, filed on Nov. 13, 2006.

(30) Foreign Application Priority Data
Mar. 12, 2003 (AU) 2003901114
Jun. 11, 2003 (AU) 2003902895

(51) Int. Cl. F21V 21/00; H01J 9/00

(52) U.S. Cl. 362/249.02; 445/22

(57) ABSTRACT

A process for producing a lamp, including forming one or more electrical connectors having a predetermined shape for making electrical connections to one or more light source assemblies mounted at predetermined locations on a non-planar support. The light source assemblies are formed by forming an electrical insulator on a peripheral region of an electrically conductive receptacle, forming an electrically conductive contact adapted to fit the peripheral region, attaching the electrically conductive contact to the electrical insulator, mounting a light source in the receptacle, and making a first electrical connection between a first electrically conductive contact of the receptacle and a first contact of the light source, and a second electrical connection between a second electrically conductive contact of the receptacle and a second contact of the light source. The light sources mounted in the electrically conductive receptacles are light emitting diodes and are encapsulated in transparent medium. An array of electrically conductive receptacles is formed from sheet metal by stamping and cutting. Connected receptacles are subsequently separated from the sheet, The electrical connectors are first and second annular connectors with projections and are formed from a metal sheet and subsequently separated by removing joining portions and tie bars.

### RELATED APPLICATIONS

This application is a divisional of U.S. patent application Ser. No. 10/548,498, filed Nov. 13, 2006, which is a National Stage Entry of Application No. PCT/AU04/00283, filed Mar. 5, 2004, which claims the benefit of priority from Australian Application Nos. 2003901114 filed Mar. 12, 2003, and 2003902895 filed Jun. 11, 2003; all of which are incorporated by reference herein in their entireties.

### FIELD OF THE INVENTION

The present invention relates to a lamp incorporating solid-state light sources such as light-emitting diodes (LEDs), and a process for producing a lamp.

The present invention is an improvement on the subject matter of International Patent No. PCT/AU03/00724, the entire subject matter of which is incorporated herein by reference.

### BACKGROUND TO THE INVENTION

Solid-state light sources, such as light emitting diodes (LEDs), are often proposed as the light sources of the future for both specialist and general lighting applications. Recent improvements in the efficiency and the colours and intensity of illumination produced by such devices has led to their increasing adoption for many lighting applications. Even though LEDs are not yet as efficient as fluorescent light sources, their extremely long lifetime has led to their widespread use in non-domestic lighting applications.

In order to obtain a sufficient intensity of light for many applications, lamps have been developed that include many individual LEDs grouped together to provide a high intensity light beam that has the appearance of being produced by a single light source. Because the divergence of the light beam produced by each individual LED is relatively small, the LEDs can be arranged in slightly different orientations (e.g., on a non-planar surface) to provide a composite light beam having a relatively large angular divergence suitable for general lighting applications, as described in International Patent No. PCT/AU03/00724.

Unfortunately, existing processes for producing such lamps are time consuming, difficult, and consequently expensive. In particular, the making of electrical connections to the individual light sources in such lamps can involve non-standard assembly processes that can be quite cumbersome. For example, electrical connections to LEDs have previously been made using wire bonding machines. However, this can be difficult when these connections are to be made between connection points that are not in the same horizontal plane, such as when the LEDs are mounted on a non-planar surface, because wire bonding machines are not readily suited to making such connections.

A further difficulty of existing lamps incorporating solid-state light sources is the heat generated by these devices, which in the case of standard LEDs is of the order of one Watt per square millimetre. Standard LEDs typically produce about 100 milliWatts of heat, which, when the LEDs are packaged individually, is quite manageable. Even in densely packed arrays with many such LEDs, the heat dissipation issue can be successfully addressed. However, larger LEDs with areas exceeding one square millimetre are now becoming commonplace, and each of these LEDs can generate more than one Watt of heat. Because this heat is generated in a small physical volume, and the surface area of each LED is small, the temperature of each LED can rise dramatically unless this heat can be effectively dissipated. In general, LEDs operate less efficiently as the temperature of the active region increases. There is also a strong body of evidence to suggest that LEDs are degraded by extended operation at high temperatures.

It is desired to provide a lamp, a process for producing a lamp, an electrically conductive sheet, and an array of electrically conductive receptacles that alleviate one or more difficulties of the prior art, or at least that provide a useful alternative.

### SUMMARY OF THE INVENTION

In accordance with the present invention, there is provided a process for producing a lamp, including forming one or more electrical connectors having a predetermined shape for making electrical connections to one or more light source assemblies mounted at predetermined locations on a non-planar support.

The present invention also provides a process for producing a lamp, including:
forming an electrical insulator on a peripheral region of an electrically conductive receptacle;
forming an electrically conductive contact on said peripheral region;
attaching said electrically conductive contact to said electrical insulator;
mounting a light source in said receptacle; and
making a first electrical connection between a first electrically conductive contact of said receptacle and a first contact of said light source, and a second electrical connection between a second electrically conductive contact of said receptacle and a second contact of said light source.

The present invention also provides a process for producing a plurality of lamps, including:
forming an array of electrically conductive receptacles interconnected by receptacle joining portions;
forming electrical insulators on respective regions of said receptacles;
attaching electrically conductive contacts to said electrical insulators;
mounting light sources in said receptacles; and
making a first electrical connection between a first contact of each light source and a first electrically conductive contact of the receptacle in which it is mounted, and a second electrical connection between a second contact of the light source and a second electrically conductive contact of the receptacle to provide a plurality of light source assemblies.

The present invention also provides a light source assembly produced by any of the above processes.

The present invention also provides a lamp assembly produced by any of the above processes.

The present invention also provides a lamp produced by any of the above processes.

The present invention also provides a lamp production system having components for executing the steps of any of the above processes.

The present invention also provides an electrically conductive sheet including a plurality of electrical connectors interconnected by joining portions, said electrical connectors adapted to make electrical connections to one or more light source assemblies mounted at predetermined locations on a non-planar support.

The present invention also provides an array of electrically conductive receptacles for receiving respective light sources, said receptacles interconnected by receptacle joining portions.

### BRIEF DESCRIPTION OF THE DRAWINGS

Preferred embodiments of the present invention are hereinafter described, by way of example only, with reference to the accompanying drawings, wherein:

FIGS. 1 to 3 are perspective, side, and plan views, respectively, of a lamp assembly according to one preferred embodiment of the invention;

FIG. 4 is a flow diagram of a lamp production process according to one preferred embodiment of the invention;

FIG. 5 is a flow diagram of a cup assembly process forming part of the lamp production process of FIG. 4;

FIG. 6 is a plan view of an array of cups used in lamp assemblies of the type shown in FIGS. 1 to 3;

FIG. 7 is a plan view of a single cup of the cup array;

FIG. 8 shows a plan view and a cross-sectional side view of the cup separated from array;

FIG. 9 is a plan view of an array of cup contact rings of the lamp assembly;

FIG. 10 is a plan view of a single cup contact ring of the cup contact ring array;

FIG. 11 shows a plan view and a cross-sectional side view of the cup contact ring separated from the cup contact ring array;

FIG. 12 is a plan view of a cup assembly of the lamp assembly;

FIG. 13 is a side cross-section view of the cup assembly;

FIG. 14 is a plan view of a cup support lead frame of the lamp;

FIG. 15 is a plan view of the cup support lead frame after its curved portion has been partitioned into three portions and three openings have been cut in each portion, and showing three cup assemblies mounted in the openings in a left hand portion;

FIG. 16 is a plan view of an array of annular connector pairs of the lamp;

FIG. 17 is a plan view of a single annular connector pair of the annular connector array;

FIGS. 18 and 19 are plan views of inner and outer annular connectors, respectively, of the annular connector pair;

FIG. 20 is a side view of the cup support lead frame encapsulated within an optical package;

FIG. 21 is a side view of the encapsulated cup support lead frame clamped between cover and base components of an outer package;

FIG. 22 shows plan and side views of the cover of the outer package;

FIG. 23 shows plan and side views of the base of the outer package;

FIG. 24 shows plan and side views of the encapsulated lamp assembly in the outer package;

FIG. 25 is a side view of the encapsulated and packaged lamp assembly after lead forming;

FIGS. 26 and 27 are plan and side views, respectively, of the packaged and encapsulated cup support lead frame prior to removal of redundant portions of the lead frame sheet;

FIG. 28 is a side view of the lamp;

FIG. 29 is a side view of an alternative embodiment of a lamp having an alternative arrangement of contact leads;

FIGS. 30 and 31 show plan and cross-sectional side views, respectively, of an alternative cup assembly having a circular encapsulant;

FIGS. 32 to 34 are perspective, side, and plan views, respectively, of a further alternative lamp assembly;

FIG. 35 is a plan view of yet a further alternative cup support lead frame partitioned into twelve portions for supporting respective cup assemblies, and using an alternative contact configuration; and

FIG. 36 is a plan view of yet another further alternative and unpartitioned cup support lead frame supporting twelve cup assemblies, having a contact configuration that allows each cup assembly to be independently controlled.

### DETAILED DESCRIPTION OF THE PREFERRED EMBODIMENTS

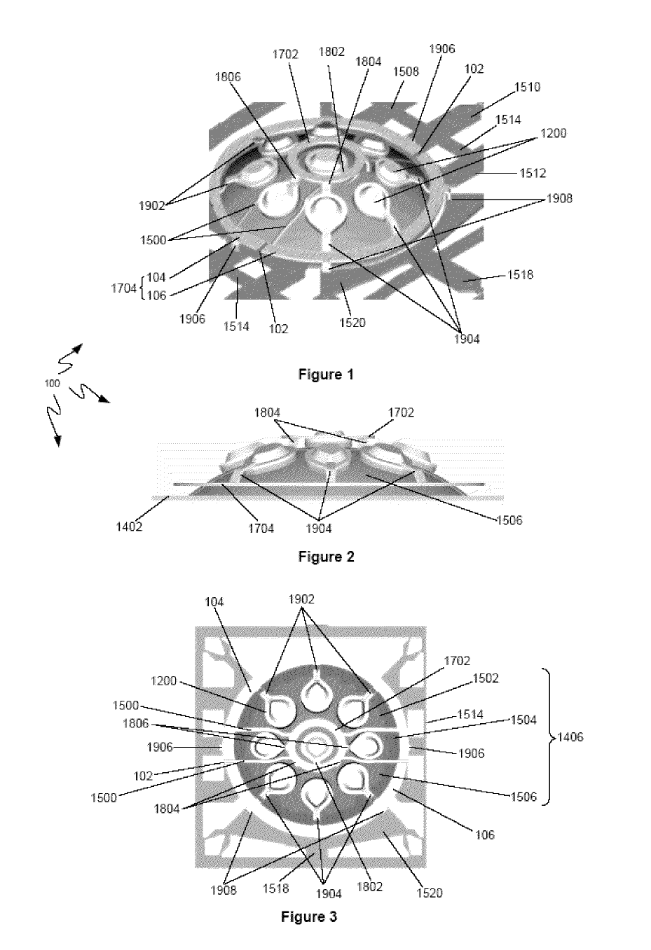

A lamp includes a lamp assembly 100, as shown in FIGS. 1 to 3, including nine light source assemblies 1200 mounted on an electrically conductive light source support 1406. Each of the light source assemblies 1200 contains a light source, being a light-emitting diode (LED) that emits a beam of light from its surface when electric current is passed through the LED. Each LED is preferably of a type having a relatively large active area (e.g., in the range 0.5-1.5 mm²), requiring an operating current which can be up to 350-400 mA; however, smaller area LEDs can alternatively be used.

The LEDs are mounted on the concave side of each light source assembly 1200 and are therefore not visible in FIGS. 1 to 3. In the arrangement shown, the light source assemblies 1200 are mounted on the convex outer surface of the support 1406 with their base part directed towards the concave inner side of the light source support 1406. Consequently, the light beams generated by the LEDs point in different directions, providing uniform illumination over a relatively wide divergence angle suitable for many lighting applications.

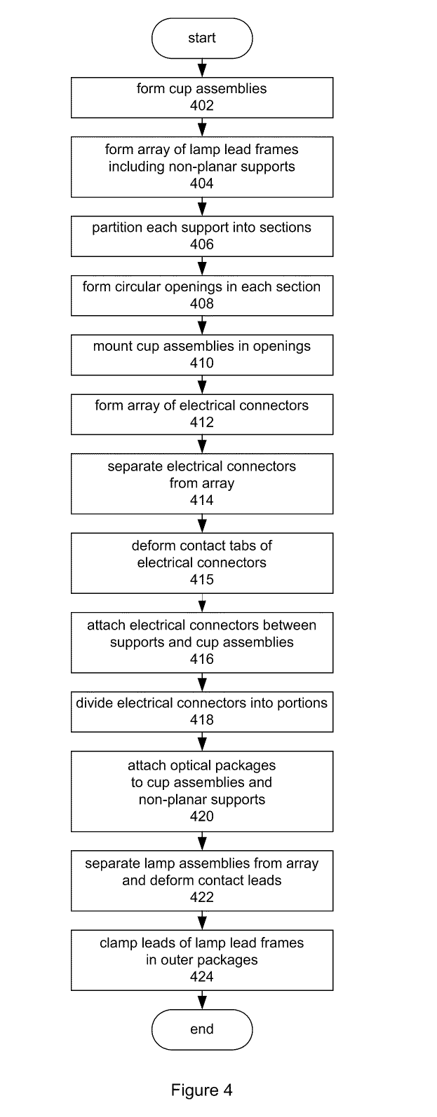

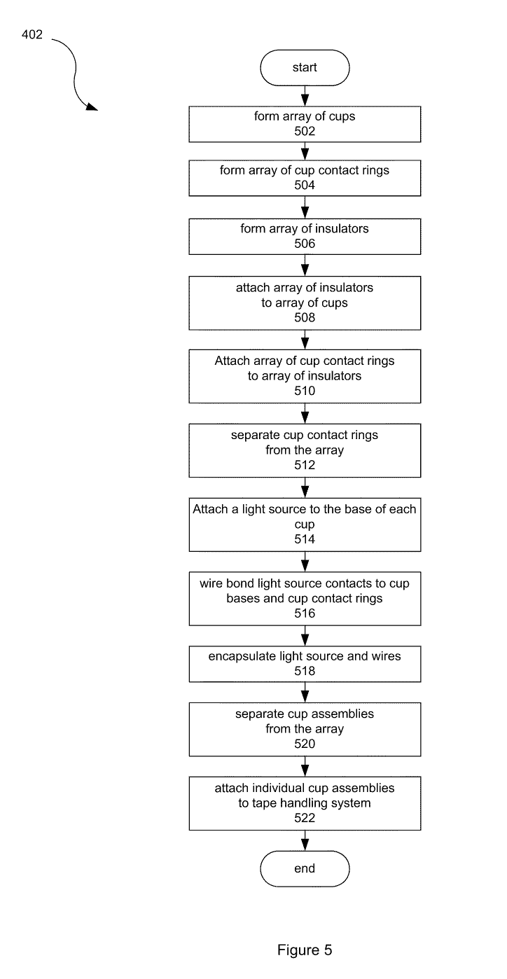

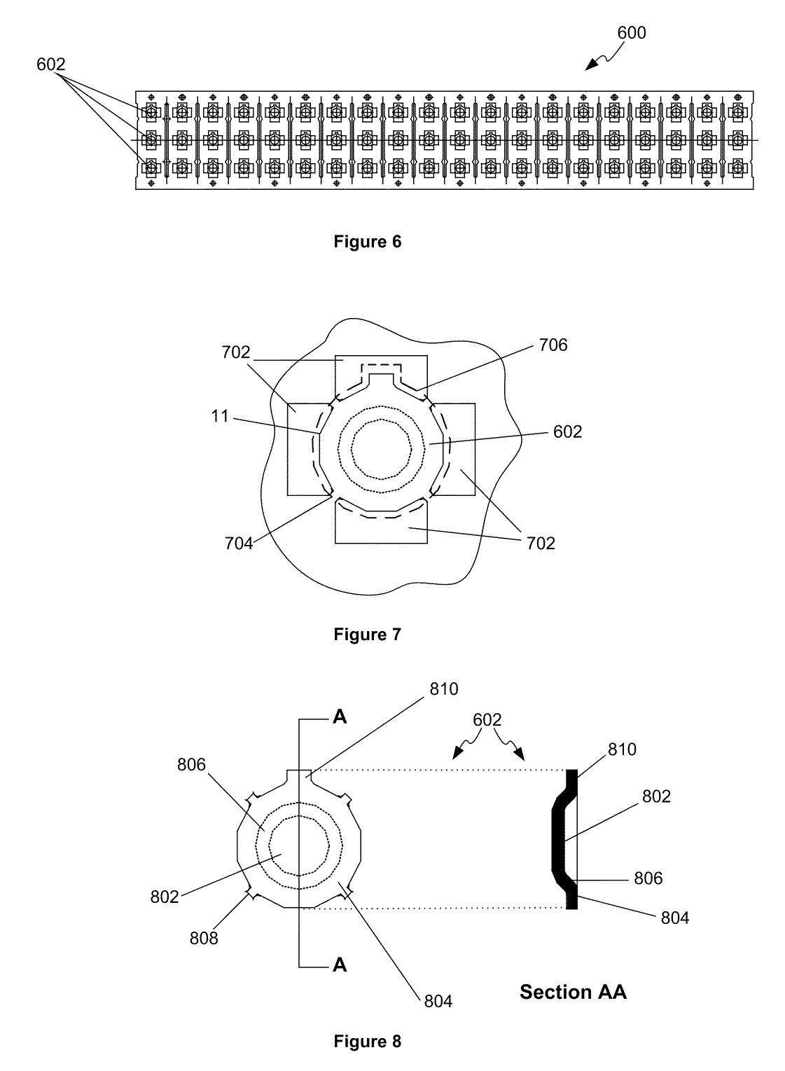

The lamp 100 is made by executing a lamp production process, as shown in FIG. 4. The lamp production process is a batch process whereby many instances of the lamp 100 are made simultaneously in an array form. The process begins by forming light source assemblies 1200, referred to hereinafter as cup assemblies 1200, using a cup assembly process 402, as shown in FIG. 5. This process begins by forming an array 600 of cup or bowl-shaped receptacles 602 referred to hereinafter as cups 602, as shown in FIG. 6. The cup array 600 is manufactured from relatively thick (e.g., at least 0.3 mm) sheet metal to provide an electrically conductive cup that allows substantial heat flow through the cup 602. However, it will be apparent that the cups 602 can alternatively be manufactured from any other material having substantial electrical and thermal conductivity and mechanical rigidity. The array 600 can be produced in continuous roll form from a sheet of suitable material, or alternately in discrete lengths, as illustrated.

As shown in FIG. 7, each cup 602 is formed using a standard stamping technique to deform the sheet to create the cup depressions or cavities, and removing portions 702 of the sheet. The cup 602 remains connected to the sheet by joining portions 704. As described below, the cups 602 are separated from the array 600 in a later step by cutting the joining portions 704 along the path 706. For the purposes of illustration, FIG. 8 provides a plan view and a side-view cross-section of a separated cup 602. The cup 602 is generally shaped like a bowl or shallow cup having a recess defined by a flat base 802 and an outer rim 804 joined by sloping sides 806. The cup includes residual portions 808 of the joining portions 704, and a contact area or tab 810 projecting outwards from the rim 804.

After the cup array 600 has been formed, an array 900 of contact loops or rings 902 is formed at step 504 by stamping, etching, laser cutting, or some other form of machining, or whichever method was used to form the cup array 600, except that the sheet metal from which the contact rings 902 are formed is thinner that that used in the cups 602 because the contact rings 902 do not need to conduct heat. As shown in FIG. 10, each contact ring 902 is formed by removing portions 1002 from the sheet, leaving the contact ring attached to the array 900 by contact ring joining portions 1004. The contact rings 902 are separated from the array 900 in a later step by cutting the joining portions 1004 using a cutting tool to follow a cutting path 1006. The cutting tool also follows a second cutting path 1008 to remove a central portion from the contact ring 902 to define a circular loop or ring structure with a central hole 1010. FIG. 11 shows a plan view and a side view cross-section of the contact ring 902 after cutting. The contact ring 902 includes an outwardly projecting contact area or tab 1102 in the plane of the ring 902.

The outer dimensions of each contact ring 902 are the same as those of the rim 804 and contact tab 810 of each cup 602. Although the cup rims 804 and contact loops or rings 902 are shown having a generally keyhole-like shape comprising a circular annular loop with a sharply-defined outwardly projecting contact area 810,1102, other shapes can be alternatively used, although it is preferred that the cup rims and contact loops have at least the same outer shape so that they can be easily aligned relative to each other. For example, alternative embodiments can be devised in which the annular cup rims and contact loops are not circular in shape, but could alternatively be oval, square, or rectangular annular loops, for example. Furthermore, although it is preferred that the loops are closed, it can be envisaged that the loops could be open loops including a small gap.

At step 506, an array (not shown) of loop or ring-shaped insulators 1302 having the same dimensions (with the possible exception of thickness) and orientation as the contact rings 602 is formed from a sheet of electrically insulating material such as Polyimide. Alternatively, the sheet of insulation can be formed as an array of circular holes having the same diameter as the inner diameter of the contact rings 602. In either case, excess insulation is trimmed from the assembly in a later operation, as described below.

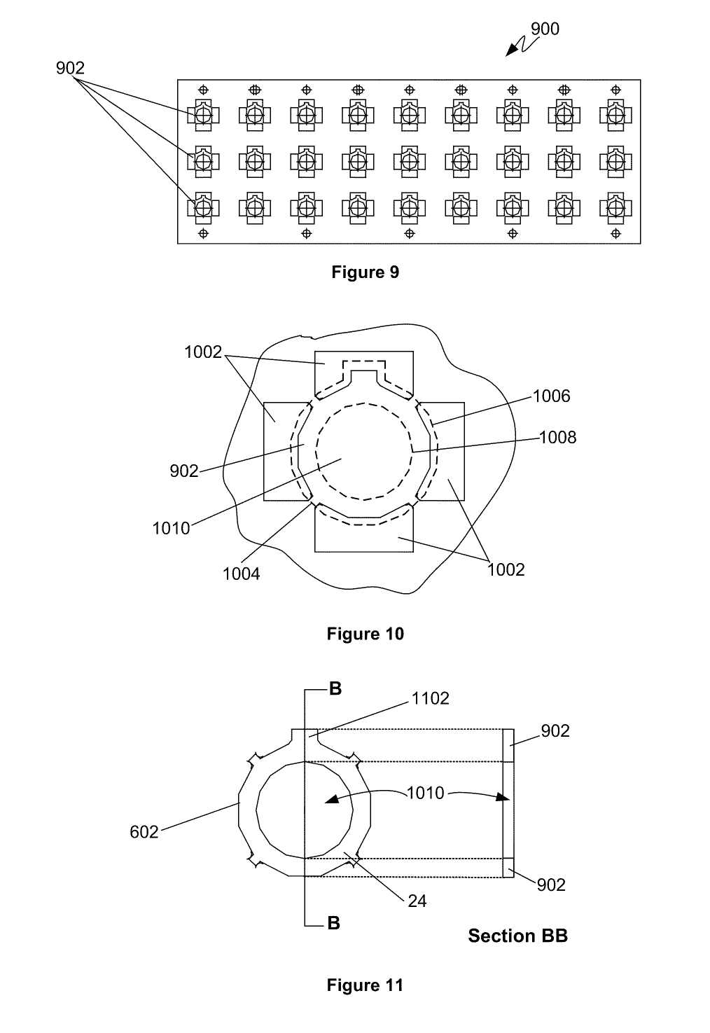

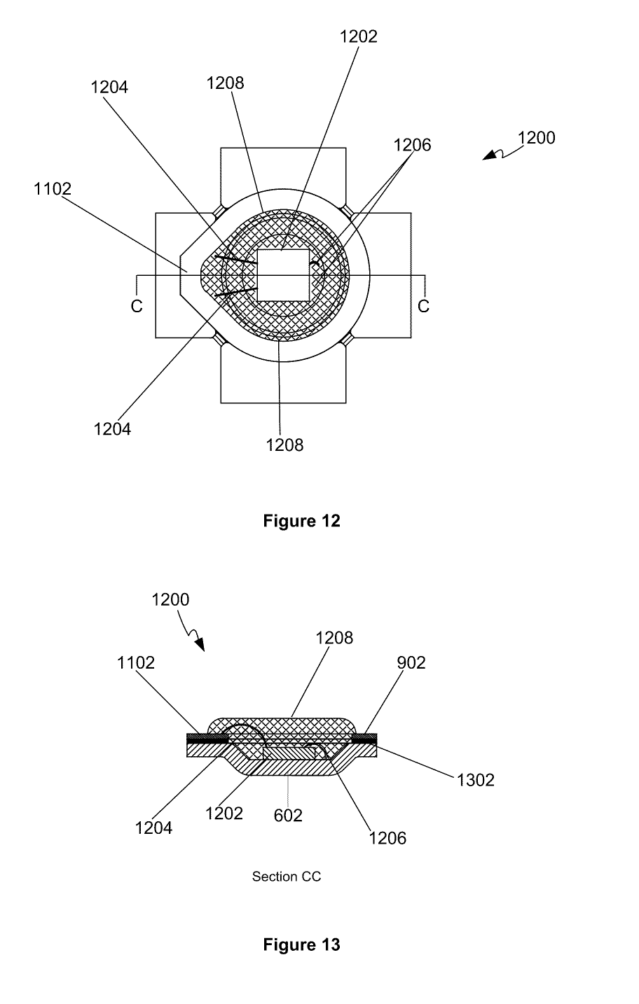

FIGS. 12 and 13 are plan and side cross-section views, respectively, of a cup assembly 1200 of an array of cup assemblies 1200 produced by subsequent steps 508 to 518 of the cup assembly process. Other than FIGS. 6 to 11, the cup rims 804 insulators 1302, and contact loops or rings 902 are shown having a common teardrop-like outer shape as an alternative to the keyhole-like shape shown in FIGS. 6 to 11.

The steps for producing the cup assembly 1200 from the cup array 600, the contact ring array 900, and the insulator array are as follows. At step 508, the insulators 1302 of the insulator array are permanently attached to respective rims 804 of the cup array 600, and at step 510, the contact rings 902 of the contact ring array 900 are permanently attached to the insulators 1302 of the insulator array. These attachments are achieved using a standard adhesive such as a pressure sensitive thermosetting type. The result is that the contact rings 902 lie over, and are electrically insulated from, the rims 804 of the cups 602.

Alternatively, insulators can be formed by wiping the rims 804 of the cups with a pad saturated with a suitable liquid phase insulator, or by direct screen printing. Suitable insulation materials include uncured epoxy which can be polymerised at relatively low temperatures, or semi-cured thermosetting epoxy. In this case, the contact ring array 900 can be applied to the insulators while they are uncured or semi-cured so that the curing process bonds the contact rings 902 to the rims 804 of the cups 602 via the insulation.

At step 512, the joining portions 1004 of the contact ring array 900 are cut to separate the contact rings 902 from the array 900. At step 514, an LED 1202 is attached to the base 802 of each cup 602 by a conductive adhesive. Each LED 1202 includes two terminals or contacts for providing electrical current to the LED 1202. At step 516, one or more electrical contacts of a first polarity are electrically connected to the contact tab 1102 of the corresponding contact ring 902 by first gold wires 1204, and one or more contacts of a second polarity are connected to the inside surface of the corresponding cup 602 by second gold wires 1206. The gold wire connections 1204, 1206 are formed by standard wire bonding methods. The result of these steps is referred to as an intermediate cup assembly.

Alternatively, if each LED 1202 includes a contact pad on its underside, it will be apparent that the second bonding wires 1206 between the LED chips and the cups are not required, because in such a case the conductive adhesive that attaches the LED die 1202 to the cup 602 provides an electrical connection of the second polarity.

At step 518, the LEDs 1202 and corresponding contact wires 1204, 1206 are encapsulated in an optically transparent medium 1208 to protect the LEDs 1202 and bonding wires 1204, 1206. As shown in FIG. 12, the encapsulant 1208 is shaped like a teardrop in plan view so as to incorporate all of the first gold wires 1204.

The encapsulation 1208 is formed by a standard moulding method such as transfer moulding, book moulding or plate moulding, using a thermosetting encapsulant. The mould (not shown) used to form the encapsulants 1208 includes an array of mould cavities dimensioned to receive a composite array of cups 602, insulators 1302, and contact rings 902, complete with attached LEDs 1202 and bonding wires 1204, 1206.

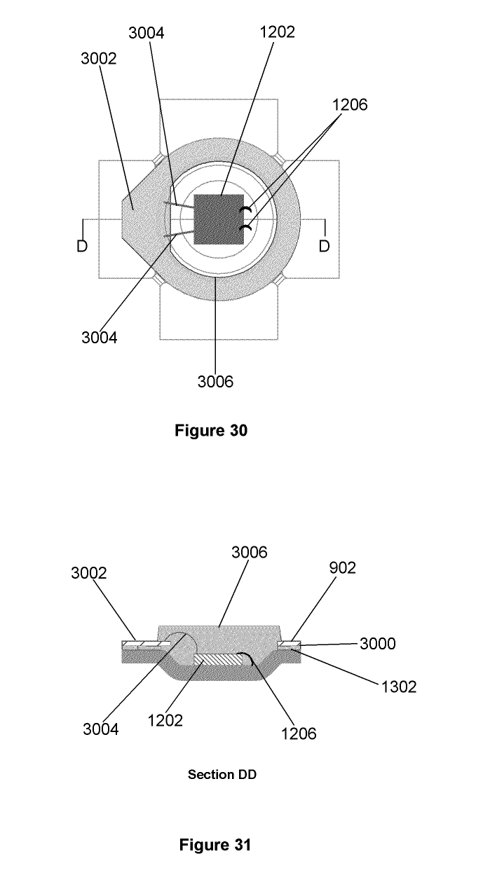

In an alternative embodiment, a contact ring 3000 is formed having an inner opening that is not completely circular, but rather is truncated on the part of the opening near the contact area 3002 of the contact ring 3000, as shown in FIGS. 30 and 31. Consequently, when the contact ring 3000 is attached to the insulator 1302, the contact ring 3000 protrudes inside the inner diameter of the cup rim 804 to overhang the cup recess slightly. This allows bonding wires 3004 to be terminated inside the inner diameter of the cup rim, which in turn allows encapsulation 3006 having a circular shape in plan view, as opposed to the teardrop-shaped encapsulation 1208 shown in FIG. 12.

In either case, the encapsulation material is selected to have high thermal conductivity, high electrical resistivity, a low coefficient of thermal expansion, high transmission of visible light, high refractive index, high tolerance to near-UV radiation, good temperature stability and low water absorption. Moulding processes that use material other than thermosetting material are generally less desirable for various reasons. In particular, thermoplastic moulding may cause delicate components to fail by subjecting them to excessive pressure and/or thermal budget (i.e., temperature/time combination). To address this difficulty, the array of encapsulants 1208 can alternatively be pre-formed and then attached to each intermediate cup assembly. This greatly increases the range of suitable encapsulant materials because the pre-formed modules can be produced from a wider range of materials and processes requiring high temperatures and/or pressures.

Each cup assembly 1200 of the resulting array of cup assemblies 1200 is then separated from the array at step 520 by cutting the sheet metal joining portions 704 of the cup array 900, the contact ring joining portions 1004, and any excess insulation, along the cutting path 706. At step 522, the individual cup assemblies 1200 are then attached to a tape handling system. This completes the cup assembly process 402.

Each cup assembly 1200 constitutes an individually operable light source that is easy to handle and can be used in a variety of applications in addition to the lamp described herein. Because the two contact regions of the LED 1202 are electrically connected to the cup body 602 and the contact ring 902, respectively, further electrical connections necessary for providing power to the LED 1202 can be made easily by applying electrical contacts to the cup body 602 and the contact ring 902. Unlike the electrical connections made to the contact areas of the LED 1202, these contacts can be made with macroscopic connectors and do not need to be located with great precision. The cup assemblies 1200 are robust because the gold contact wires 1204, 1206 and the LED 1202 are protected by the encapsulant 1208.

A cup assembly 1200 provides light when an electrical current passes through the LED 1202. This is achieved by impressing electrical energy of an appropriate first polarity on the contact tab 1102 of the contact ring 24, and simultaneously applying electrical energy of a second, opposite polarity to the electrically conductive cup 602.

The cup assemblies 1200 provide an effective means of both electrical and thermal conduction through the body of the cup 602. It is important that the heat generated by the action of electrical current flowing through the cup assembly 1200 be effectively conducted away from the LED 1202 for a number of reasons. For example, the efficiency of light generation in the LED 1202 decreases with increasing temperature. Moreover, high temperatures may also cause failures of lamp assembly components; for example, by fracturing the bonding wires 1204, 1206, or detaching the LED chip 1202 from the cup base 802 by virtue of different rates of thermal expansion. Even if there is no catastrophic failure of the cup assembly 1200, the efficiency of the LED 1202 may be permanently degraded by operation at excessively high temperatures.

In light of the above, it is desirable to mount the cup assemblies 1200 on a support that is thermally conductive to provide a thermally conductive path along which excess heat can be conducted away, and that is also electrically conductive in order to simplify electrical connection to the cup assemblies 1200.

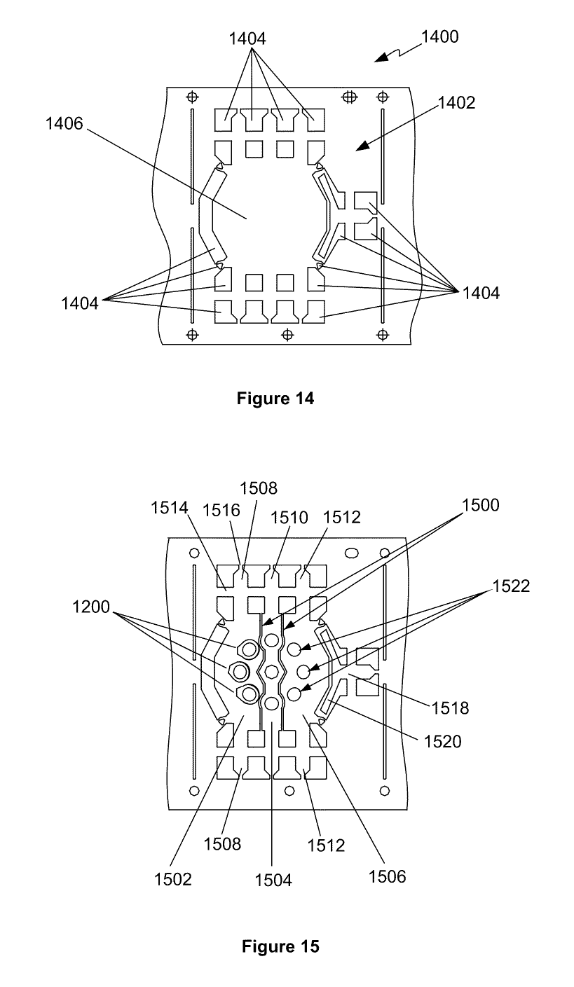

Returning to FIG. 4, an array of lamp lead frames including non-planar supports is formed at step 404 of the lamp production process. FIG. 14 is a plan view of a portion of the one-dimensional array 1400 of lamp lead frames 1402, illustrating a single lamp lead frame 1402. The array 1400 is produced as a continuous strip or as sheets of discrete length by machining sheet metal to remove twenty four portions 1404, as shown, or an equivalent number of portions for an alternate lead frame arrangement. Alternatively, the array 1400 can be manufactured from some other material having substantial electrical and thermal conductivity.

The lead frame 1402 includes a central portion or support 1406 that is deformed out of the plane of the array 1400 so that the central portion 1406 is non-planar and is curved like a dome or part of a spherical shell. The deformation can be performed simultaneously with removal of the portions 1404 (e.g., by stamping), or can be performed in a separate step.

At step 406, two partitions 1500 are cut through the domed central portion or support 1406, dividing it into three support portions 1502, 1504, 1506, as shown in FIG. 15. Elongated electrical contact leads 1508, 1510, 1512 at either end of the respective support portions 1502, 1504, 1506 provide a convenient means for making electrical connections to the support portions 1502, 1504, 1506. Until the lead frame 1402 is separated from the array 1400 in a later step, the contact leads 1508 are not electrically isolated from each other due to the presence of the lateral joining portions 1514 and longitudinal joining portions 1516 attaching the pointed end of each contact lead 1508 to 1512 to the surrounding sheet material. A lateral contact lead 1518 provides means for making electrical contact to a terminal 1520, as described below.

The cutting of the two partitions 1500 and the nine holes 1522 is performed by machining with a laser beam or other precision cutting process. Each lamp lead frame 1402 is positioned on a table equipped with a multiple axis indexing system, and the cutting tool is operated and moved or rotated in synchronism with the indexing system to produce the partitions 1500 which correspond to the contact lead configuration of the lamp lead frame 1402.

At step 408, three circular openings or holes 1522 are also cut into each of the support portions 1502, 1504, 1506 for receiving respective cup assemblies 1200, as shown in the left-hand support portion 1502 in FIG. 15. The attachment of cup assemblies 1200 to the support portions 1502, 1504, 1506 is achieved at step 410 using conductive adhesive (e.g., a paste incorporating colloidal silver particles), solder, welding or any other means that establishes good electrical and thermal continuity.

In the described embodiment, the cup assemblies 1200 are oriented so that each cup 602 is directly attached and electrically connected to the support portions 1502, 1504, 1506, and light emitted from the cup assemblies 1200 is directed upwards (i.e., generally towards from the viewer in FIG. 15). However, the cup assemblies 1200 can alternatively be mounted in an opposite orientation so that the contact rings 902 are directly attached and electrically connected to the support portions 1502, 1504, 1506, and light emitted from the cup assemblies 1200 is then directed downwards towards the concave sides of the support portions 1502, 1504, 1506 (i.e., generally away from the viewer in FIG. 15).

By mounting the cup assemblies 1200 directly on the support portions 1502, 1504, 1506 using an electrically conductive attachment medium, electrical connections are made between each support portion and the cups 602 (or contact rings 602, if oriented oppositely as described above) of the cup assemblies 1200 mounted on that support portion. Thus electric current can be supplied to each LED 1202 via a first electrical connection to either of the contact leads for the support portion on which the corresponding cup assembly 1200 is mounted, and via a second electrical connection made to the contact ring 602 of that cup assembly 1200. Alternatively, the cup assemblies 1200 can be mounted in the opposite orientation, with the contact rings 602 making the electrical connection to the support portions 1502, 1504, 1506 and a second electrical connection is then made to the cup 602.

As described in International Patent No. PCT/AU03/00724, the second electrical connection could be made using a wire bonder to bond fine (≈25 μm diameter) gold wire to the cup 1200. However, although this wire is sufficient for carrying the relatively small electric current required by a small-area LED (e.g., 20-50 mA), the larger current (e.g., 350-400 mA) required by each of the large-area LEDs 1202, if used in the lamp, requires a gold wire having a cross-sectional area at least 8-20 times larger or, equivalently, at least 3-5 times larger in diameter, or an equivalent number of gold wires used in parallel to make each connection. However, it is expensive to use more gold per item. Aluminium, on the other hand, is not as expensive as gold, but it is not as good a conductor, so that an aluminium bonding wire would need to have a larger diameter than a gold bonding wire carrying the same current. When used with large area LEDs 1202, aluminium wires with sufficient current carrying capacity would have a diameter large enough to make effective bonding difficult to achieve. The installation of multiple parallel wires is time consuming, inconvenient, and expensive.

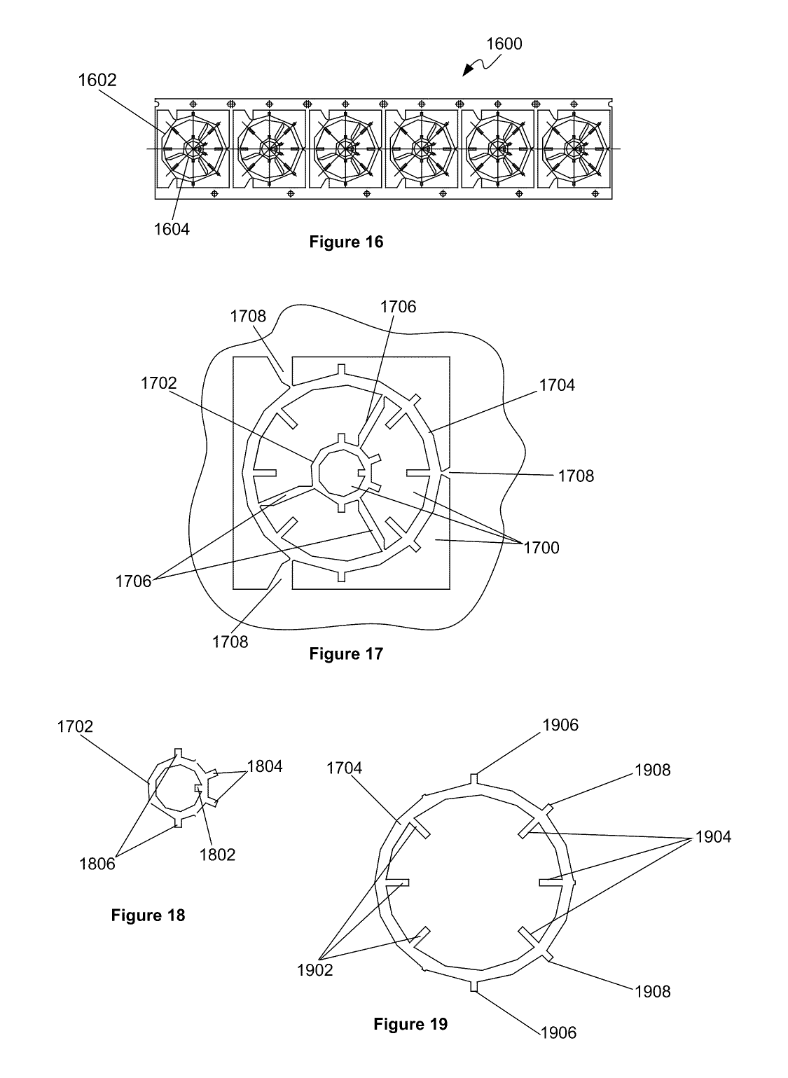

In the described embodiments, the second electrical connections are made by electrical connectors having predetermined shapes to make electrical connections to the cups 602 of the cup assemblies 1200 mounted on the curved support portions 1502, 1504, 1506. At step 412, an array 1600 of electrical connectors 1602, 1604 is formed from a metal sheet, as shown in FIG. 16. The array 1600 is fabricated as a continuous strip.

As shown in FIG. 17, the electrical connectors 1602, 1604 are formed by removing portions 1700 from the metal sheet to form a first annular inner connector 1702 and a second annular connector 1704. The first annular connector 1702 is smaller than the second annular connector 1704, allowing pairs of the two connectors 1602, 1604 to be arranged concentrically within the array 1600 and joined together by radially directed tie bars 1706. The first annular connector 1702 is therefore referred to hereinafter as the inner annular connector 1702, and the second annular connector 1704 as the outer annular connector 1704. The outer annular connector 1704 is connected to the array 1600 at three attachment points by respective outer joining portions 1708 of the surrounding sheet material.

At step 414, the annular connectors 1602, 1604 are separated from the array and from each other by removing the tie bars 1706 and shearing the outer joining portions 1708. As shown in FIG. 18, the inner annular connector 1702 includes one inwardly projecting contact tab 1802 at an angular position corresponding to an analog clock face time of 3 o'clock, and four outwardly projecting contact tabs 1804, 1806 at respective angular positions of approximately 12, 2, 4, and 6 o'clock.

As shown in FIG. 19, the outer annular connector 1704 includes:
(i) a first group of three inwardly projecting contact tabs 1902 at respective angular positions corresponding to analog clock face times of approximately 7:30, 9:00, and 10:30;
(ii) a second group of three inwardly projecting contact tabs 1904 at respective angular positions of approximately 1:30, 3:00, and 4:30;
(iii) a first pair of outwardly projecting contact tabs 1906 at respective angular positions of 12:00, and 6:00; and
(iv) a second pair of outwardly projecting contact tabs 1908 at respective angular positions of 1:30 and 4:30.

At step 415, the contact tabs 1804 to 1908 of the annular connectors 1602, 1604 (except for the inwardly projecting contact tab 1802) are deformed out of the plane of the connectors 1602, 1604, as described below. At step 416, the annular connectors 1602, 1604 are are placed concentrically over the curved support portion 1406 of the lamp lead frame 1402 after cup assemblies 1200 have been attached, and the deformed contact tabs 1804 to 1908 make electrical connections as described below.

As shown in FIG. 1, the mounting of cup assemblies 1200 on the curved support portions 1502, 1504, 1506 at step 410 is performed so that:
(i) the contact tabs 810, 1102 of the cup assemblies 1200 mounted on the two outermost curved support portions 1502, 1506 are directed radially outwards from the curved support 1406;
(ii) the contact tabs 810, 1102 of the cup assemblies 1200 mounted on the central curved support portion 1504 are directed radially inwardly; and
(iii) the contact tabs 810, 1102 of the central cup assembly are directed towards the right-hand curved support portion 1506.

The outwardly projecting contact tabs 1804 of the inner annular connector 1702 at angular positions of 2:00 and 4:00 are deformed downwards at a right angle to the plane of the inner annular connector 1702 to contact the right-hand outer curved support portion 1506. The other outwardly projecting contact tabs 1806 at 12 and 6 o'clock are deformed downwards at a smaller angle (≈30°) and these and the undeformed inwardly projecting contact tab 1802 are positioned such that they correspond with the location, orientation and position in three-dimensional space of the cup contact tabs 810 of the three cup assemblies 1200 attached to the central curved support portion 1504.

Referring now to the contact tabs 1902 to 1908 of the outer annular connector 1704, each of the six inwardly projecting contact tabs 1902, 1904 is deformed upwards to form a step-like shape, and these respectively contact the outwardly directed cup contact tabs 810 of the six cup assemblies mounted on the two outermost curved support portions 1502, 1506.

The first pair of outwardly projecting contact tabs 1906 at respective angular positions of 12:00, and 6:00 are deformed downwards to form a right-angle with the plane of the outer annular connector 1704 to contact the contact leads connected to the central curved support portion 1504.

Finally, the second pair of outwardly projecting contact tabs 1908 at respective angular positions of 1:30 and 4:30 are also deformed downwards to form a right-angle with the plane of the outer annular connector 1704, but these contact the terminal 1520.

The contact tabs 1802 to 1908 are connected electrically to their respective targets by conductive adhesive, soldering, welding, or other suitable means of establishing reliable electrical connection.

At step 418, the outer annular connector 1704 is cut in two to form a left-hand portion 104 and a right-hand portion 106, using a laser cutting tool to remove partition portions 102 in order to complete the desired electrical connections in the lamp assembly 100.

It will be apparent from the above that the components of the lamp assembly 100 are electrically connected as follows, bearing in mind that the contact lead joining portions 1514 shown in FIGS. 1 to 3 will be removed in a later step. Referring to FIG. 1, electrical current supplied through the lateral contact lead 1518 can flow up the downwardly projecting contact pins 1908 of the outer annular connector 1704, and through the inwardly projecting contact tabs 1904 to the cups 602 of the cup assemblies 1200 mounted on the right-hand curved support portion 1506. This current will flow through the LEDs mounted in these assemblies 1200, and out to the electrically conductive right-hand curved support portion 1506 itself.

From there, the current flow is into the right-hand portion 106 of the inner annular connector 1702 via the two contact tabs 1804. The current then flows through this portion 106 of the inner annular connector 1702 and into the cups 602 of the cup assemblies 1200 mounted on the central curved support portion 1504. Once again, the current flows through the LEDs mounted in these cup assemblies 1200, and out through the electrically conductive curved support portion 1504 itself. Electrical access to the central curved support portion 1504 is provided by the corresponding contact leads 1510, and the current flows through these and out into the left-hand portion 104 of the outer annular connector 1704 via the deformed contact tabs 1906. The current then flows through this portion 104 of the outer annular connector 1704 and into the cup assemblies 1200 mounted on the left-hand curved support 1502, through these cup assemblies, through the electrically conductive left-hand curved support 1502, and finally leaving the lamp assembly 100 from the left-hand contact leads 1508. It will be apparent that the direction of current flow depends upon which LED contact is connected to the cup 602 of each cup assembly 1200.

Thus the lamp assembly 100 includes nine cup assemblies 1200 which are arranged in three series-connected groups of three parallel-connected assemblies 1200 with one termination at the terminal contact 1518, and the other at the left-hand contact leads 1508 of the left-hand curved support portion 1502. Each group of three cup assemblies 1200 connected in parallel and connected to one of the curved support portions 1502, 1504, 1506 can be controlled independently of the other two groups by supplying appropriate electrical potentials to respective contact leads 1508, 1510, 1512.

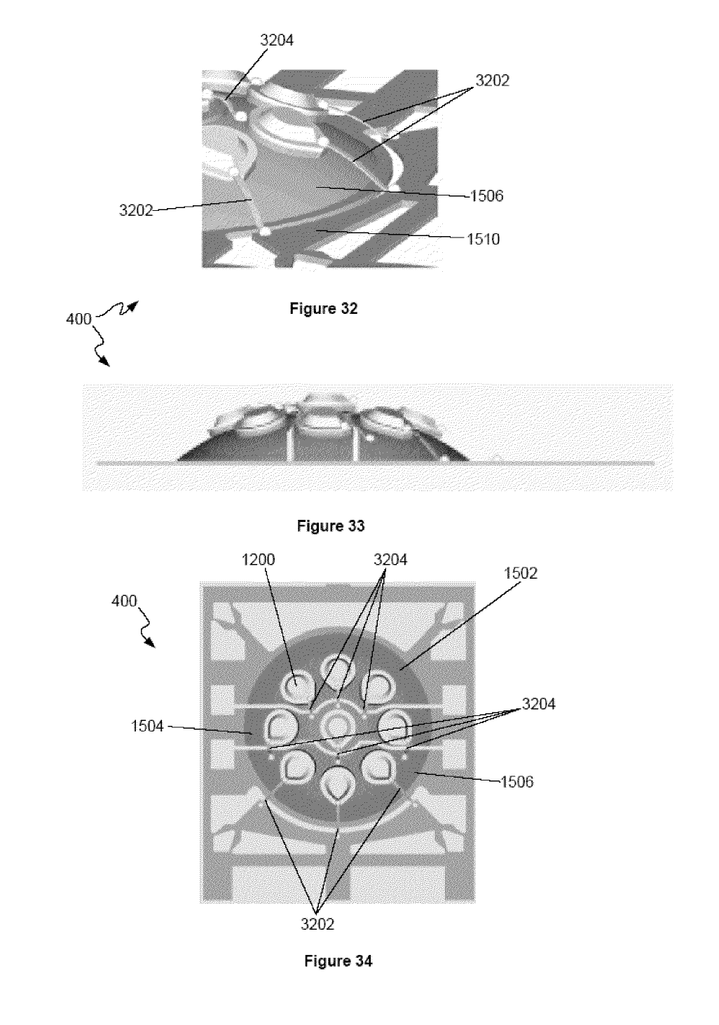

In an alternative embodiment, pre-cut pieces of wire or thin sheet metal 3202, 3204 with a relatively large cross-sectional area similar to that of the annular connectors described above, as shown in FIGS. 32 to 34, are used as the electrical connectors instead of the annular contacts described above. These connectors 3202, 3204 are formed in a predetermined shape by pre-cutting to a desired length using a laser cutting tool, stamping, etching, or other means, followed by deformation to the desired shape. Each of the resulting connectors 3202, 3204 is then positioned with both ends in simultaneous position for attaching to the lamp assembly. Attachment is performed by laser spot welding or other suitable means.

As shown in FIGS. 32 to 34, connection of the supply terminal 1510 to the three respective cup assemblies attached to the right-hand curved support portion 1512 is achieved by installing three long conductors 3202. These long conductors 3202 make connections equivalent to those made by the outwardly projecting contact tabs 1908 and the inwardly projecting contact tabs 1904 shown in FIGS. 1 to 3. Similarly, six short conductors 3204 are installed to connect the cup assemblies 1200 attached to the left-hand curved support portion 1508 and the central curved support portion 1510, and are electrically equivalent to contact tabs 1902, 1906, and 1802, 1804, 1806, respectively. Thus the two embodiments are electrically identical.

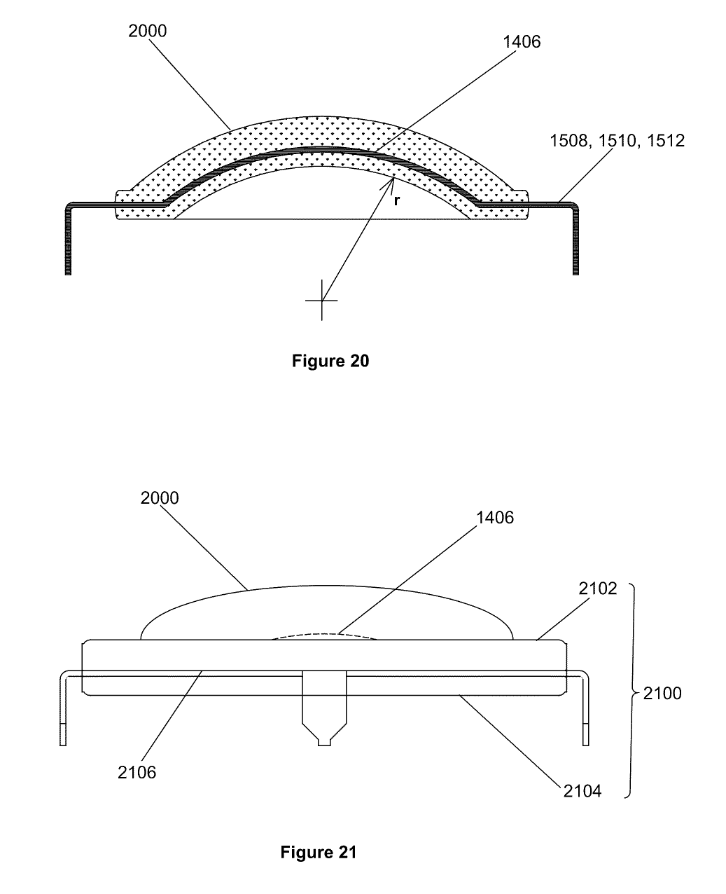

After the array of lamp assemblies 100 has been prepared, as represented by the single lamp assembly 100 shown in FIGS. 1 to 3, at step 420 an optical package 2000 is applied to the curved support 1406 and cup assemblies 1200 of each lamp assembly 100, as shown in FIG. 20. FIG. 20 is a side view section through the optically packaged lamp assembly which shows the radius of the curved support 1406 of the lamp lead frame 1402 and a spherical radius r on the underside of the package. The annular connectors 1702, 1704 and cup assemblies 1200 have been omitted for clarity. The contact leads 1508, 1510, 1512 are shown in their final, deformed state to illustrate the spatial relationship between these and the optical package 2000. The optical package 2000 is moulded over, through and beneath the lamp lead frame 1402, and consists of an optically transparent material that has similar physical properties to that moulded over cup assemblies 1200 as described above, and is preferably formed by the same or a similar process.

At step 422, each lamp assembly 100 and its optical package 2000 is separated from the array, and the contact leads 1508, 1510, 1512 are separated by removing the joining portions 1514, and are formed perpendicular to the lead frame 1402. At step 424, the contact leads 1508, 1510, 1512 of each lamp assembly 100 are clamped between a cover 2102 and a base 2104 of an outer package 2100, as shown in FIGS. 21 to 27. The outer package 2100 is pre-formed by another process and placed around the lamp lead frame 1402 and optical package assembly 2000, as shown in FIG. 21.

Returning to FIG. 20, the radius r represents a part-spherical volume beneath the optical package 2000 that can be used to enhance the thermal path from each lamp in order to avoid overheating the lamp components. The cavity thus formed can be filled with a material of higher thermal conductivity than that of the optical package material to improve the heat dissipation from the lamp. For example, a metallic insert shaped to fit the cavity can be placed in contact with both the optical package 2000 and the base 2104 of the outer package 2100. In an alternative embodiment, the base of the outer package can include a part spherical portion that contacts the underside of the optical package 2000 to provide an efficient thermal path.

The material and process used to manufacture the outer package 2100 is determined largely by the physical properties required of the package 2100. The material of which the outer package 2100 is made may be ceramic in nature; aluminium nitride (AlN) is preferred as it provides excellent thermal conductivity, but is difficult to work. Alternatively, aluminium dioxide (Al₂O₃) or a plastic material can be used, depending upon the thermal requirements. For example, a lamp using only LED chips requiring about 50 milliamps each requires only minor heat sinking due to the relatively small amount of heat to be dissipated. For the embodiments described above, this might be equivalent to about one Watt of electrical energy, and a plastic moulding should provide a satisfactory outer package. However, if larger LED chips are used, then the amount of heat to be dissipated could be equivalent to approximately ten Watts, and will therefore require a thermal path with high conductivity such as that provided by a ceramic material.

The cover 2102 and base 2104 of the outer package 2100 are sealed together with sealing material 2106 to hold the lamp lead frame 1402 firmly between them. The sealing material can be semi-cured epoxy, but other materials commonly used to secure ceramic packages can alternatively be used.

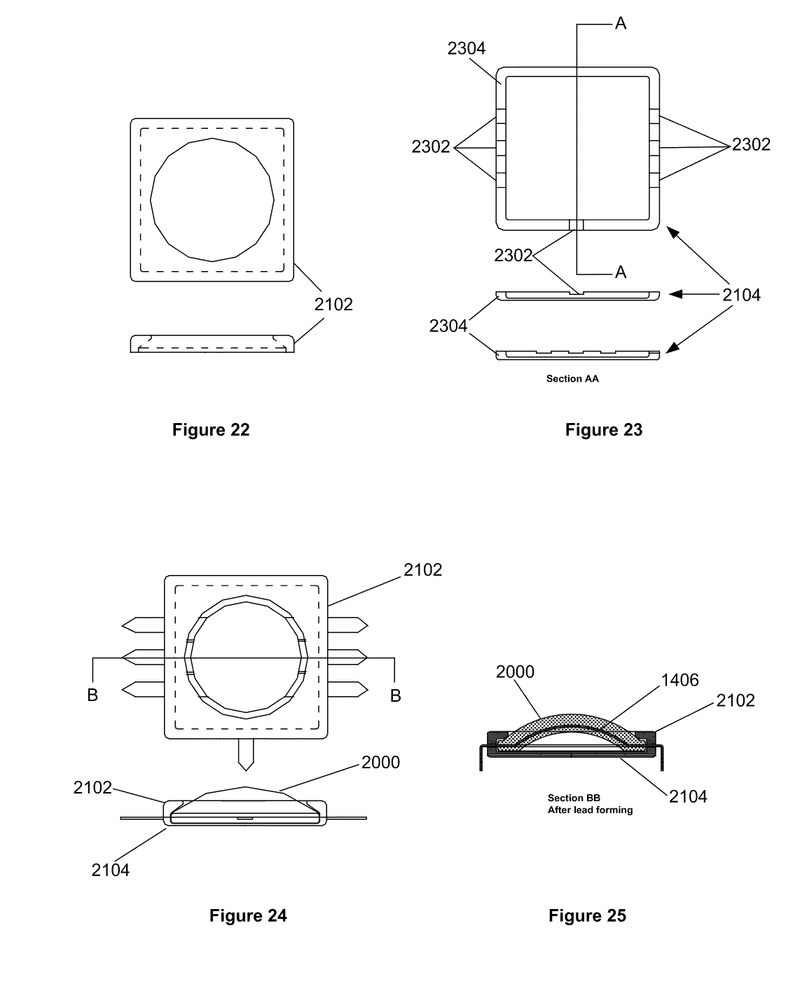

FIG. 22 provides a plan view and a side view of the cover 2102, and FIG. 23 provides a plan view and two side views of the base 2104. The base 2104 includes seven recesses 2302 in its three of its four side walls 2304. The recesses 2302 are positioned and dimensioned to snugly accommodate the contact leads 1508 to 1512 of the lamp lead frame 1402 when the cover 2102 and the base 2104 of the outer package 2100 are sealed together. Alternatively, corresponding recesses can be provided in the cover 2102 rather than the base 2104, or at omitted altogether. However, in all cases the cover 2102 and base 2104 are in close contact with the contact leads 1508 to 1512, regardless of the arrangement of the lamp lead frame 1402 and its contact leads 1508 to 1512.

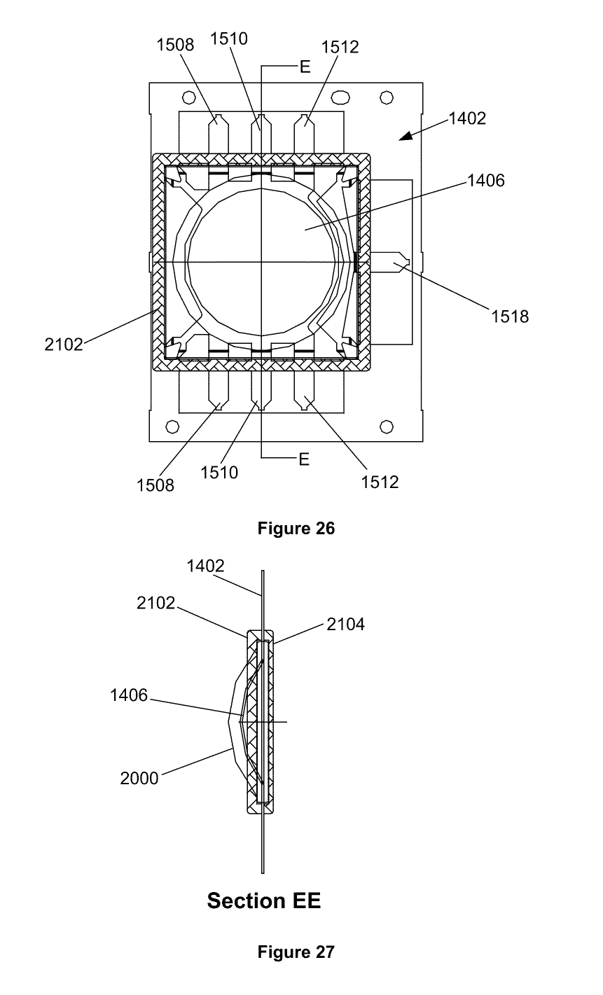

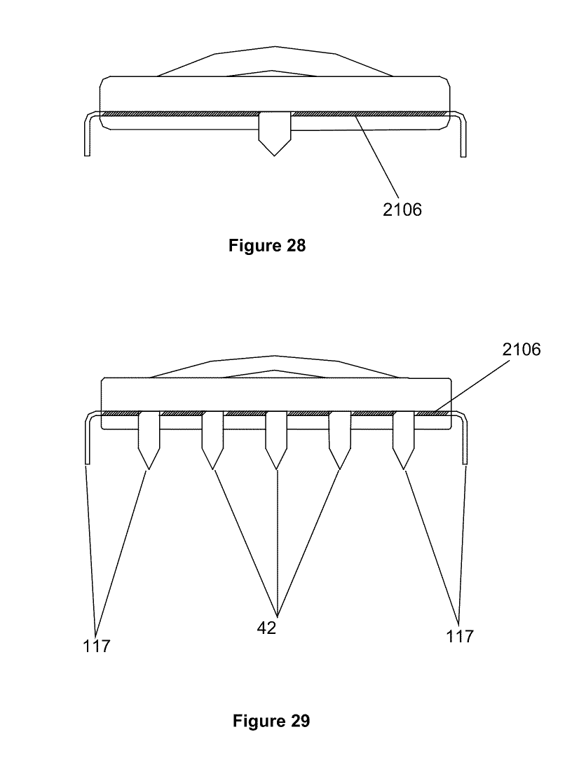

FIGS. 24 and 25 provide further views of the packaged lamp, showing only the outline of the lamp lead frame 1402 and omitting various details for clarity. FIGS. 26 and 27 provide plan and side views, respectively, of the outer package 2100 applied to a lamp lead frame 1402, showing details of the latter. FIGS. 28 and 29 are side views of an alternate arrangement of the lamp lead frame and corresponding contact leads.

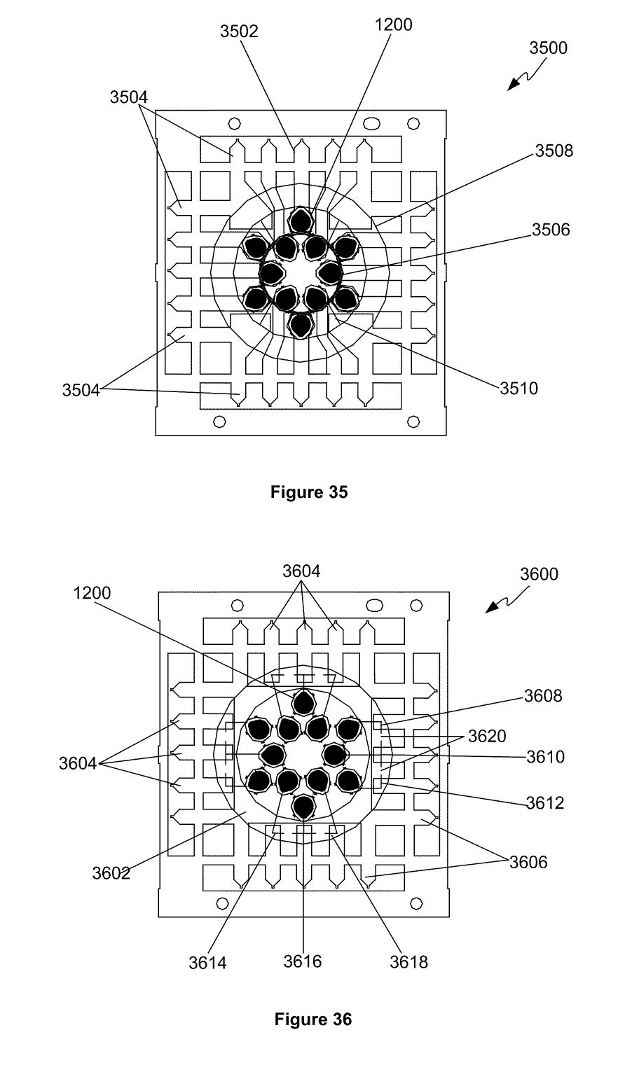

In an alternative embodiment, a lamp lead frame 3500 includes an electrically conductive curved support 3508 cut into twelve separated portions, each having an opening for receiving a corresponding cup assembly 1200, as shown in FIG. 35. The lamp lead frame 3500 includes twelve contact leads 3502 electrically connected to the respective curved support portions, and eight common contact leads 3504 connected to every cup assembly 1200. Thus each of the twelve cup assemblies 1200 can be individually controlled by controlling the flow of electrical current passing through any of the common contact leads 3504 and the corresponding contact lead connected to that cup assembly.

The common contact leads 3504 are attached to a shared circular ring contact 3506 by contact arms 3510. The circular ring contact 3506 is also attached to the contact ring 902 of each cup assembly 1200, thereby establishing an electrical connection between the common contact leads 3504 and a contact of a first polarity on the LED chip 1202 inside each of the cup assemblies 1200. The LED contact pad of a second polarity is connected to the cup 602 which in turn is in electrical contact with its respective contact lead 3502.

In yet a further alternative embodiment, a lamp lead frame 3600 includes an electrically conductive curved support 3602 having twelve openings for receiving respective cup assemblies 1200, as shown in FIG. 36. In this embodiment, the curved support 3602 is not partitioned, but instead cup assembly contact leads 3604 are separated from it. The cups 602 are connected to common contact leads 3606, which are also connected to the curved support 3602.

This arrangement therefore establishes an electrical connection between LED contact pads of a first polarity and the common contact leads 3606. Connections of a second respective polarity are made between the contact rings 902 of the cup assemblies 1200 and the respective contact leads 3604 by a first contact lead frame including parts 3608, 3610, 3612, and a second contact lead frame including parts 3614, 3616, 3618. These two contact lead frames are initially formed in a single piece and are shaped and formed to match the relative locations in three-dimensional space of the corresponding contact regions of the respective cup assemblies. To allow a separate electrical circuit to be established for each cup assembly 1200, partitions 3620 are subsequently made by cutting the contact lead frames with a laser cutting tool after the contact lead frames have been attached.

As described above, the cup assemblies 1200 described herein are not only useful with the lamp assemblies described herein, but can be used in a wide variety of other arrangements and applications. For example, the cup assemblies 1200 can be mounted in a metal cored printed circuit board (MCPCB). The MCPCB has a circuit of tracks on one side of the board which are electrically insulated from the metal core, and which can be electrically connected by standard means to the contact area 1102 of the contact ring 902 to make a first connection. A second electrical connection is established between the all of the cups 602 on the MCPCB and the metal core of the MCPCB. The metal core performs two functions: it not only provides a means of making electrical contact with the cup assemblies 1200, but also acts as a heat sink for the LEDs 1202 which are in close thermal contact with it.

Many modifications will be apparent to those skilled in the art without departing from the scope of the present invention as herein described with reference to the accompanying drawings.

1. A process for producing a lamp, including:
forming an electrically conductive receptacle having a substantially planar base and a substantially planar peripheral region;
forming a substantially planar electrical insulator on said substantially planar peripheral region;
forming a substantially planar electrically conductive contact on said substantially planar electrical insulator;
mounting a light source on said base of said receptacle;
making a first electrical connection between said substantially planar electrically conductive contact and a first contact of said light source, and a second electrical connection between said electrically conductive receptacle and a second contact of said light source; and
encapsulating said light source and said electrical connections to provide a light source assembly for mounting on an electrically conductive support, wherein an unencapsulated portion of said substantially planar electrically conductive contact provides a first electrical contact to said light source mounted in said receptacle, and the electrically conductive receptacle provides a second electrical contact to the light source.

2. A process for producing a lamp, including:
forming an array of electrically conductive receptacles interconnected by receptacle joining portions, each of said receptacles having a substantially planar base and a substantially planar peripheral region;
forming an array of substantially planar electrical insulators on said peripheral regions of said receptacles;
forming an array of substantially planar electrically conductive contacts on said electrical insulators;
mounting light sources on the bases of said array of receptacles;
making first electrical connections between a first contact of each light source and the electrically conductive contact of the corresponding receptacle, and second electrical connections between a second contact of each light source and the corresponding receptacle; and
encapsulating said light sources and said electrical connections to form an array of light source assemblies, wherein an unencapsulated portion of the substantially planar electrically conductive contact of each receptacle provides a first electrical contact to the light source mounted in that receptacle, and the electrically conductive receptacle provides a second electrical contact to the light source.

3. A process as claimed in claim 2, wherein said step of encapsulating includes forming an array of encapsulants, and attaching the array of encapsulants to said plurality of light source assemblies.

4. A process as claimed in claim 2, including forming a plurality of individual light source assemblies by removing said receptacle joining portions to separate said light source assemblies from said array.

5. A process as claimed in claim 4, including reversibly attaching said individual light source assemblies to a substrate for handling.

6. A process as claimed in claim 5, wherein said substrate includes a tape or reel handling system.

7. A process as claimed in claim 2, wherein said step of forming said array of electrically conductive contacts includes forming said array of electrically conductive contacts interconnected by contact joining portions, and attaching the contacts of said array to said electrically insulating regions, and the process includes removing said contact joining portions to separate said contacts from said array.

8. A process as claimed in claim 7, wherein said step of forming said array of electrical insulators includes forming said array of said electrical insulators interconnected by insulator joining portions, and attaching said electrical insulators of said array to respective regions of said receptacles, and the process includes removing said insulator joining portions to separate said insulators from said array.

9. A process as claimed in claim 8, including mounting two or more of said light source assemblies on a non-planar support to increase the divergence of light generated by said two or more light sources.

10. A process as claimed in claim 2, including forming an array of non-planar supports, each of said supports including holes or recesses for receiving respective light source assemblies.

11. A process as claimed in claim 9, wherein said non-planar support is partitioned into at least two support portions to enable individual control of one or more light sources electrically connected to each support portion.

12. A process as claimed in claim 10, wherein said step of forming an array of non-planar supports includes forming an array of support lead frames including said supports and contact leads for providing electric current to said supports.

13. A process as claimed in claim 9, wherein the step of making electrical connections includes:
forming a plurality of electrical connectors, each having a predetermined shape to connect one or more corresponding portions of respective light source assemblies to said support; and
attaching said electrical connectors to said light source assemblies and said support to make said electrical connections.

14. A process as claimed in claim 13, including dividing at least one of said electrical connectors into two or more portions after attaching the at least one electrical connector to said light source assemblies and said support.

15. A lamp produced by a process as claimed in claim 3.

16. A lamp produced by a process as claimed in claim 6.

17. An array of light source assemblies, including:
an array of electrically conductive receptacles for receiving respective light sources, said receptacles interconnected by receptacle joining portions, each of said receptacles having a substantially planar base and a substantially planar peripheral region;
an array of substantially planar electrical insulators on said peripheral regions of said electrically conductive receptacles;
an array of substantially planar electrically conductive contacts on said electrical insulators;
light sources mounted on the bases of said array of electrically conductive receptacles;
first electrical connections between said electrically conductive contacts and first contacts of said light sources, and second electrical connections between said electrically conductive receptacles and second contacts of said light sources; and
said light sources and said electrical connections being encapsulated, wherein an unencapsulated portion of the substantially planar electrically conductive contact of each receptacle provides a first electrical contact to the light source mounted in that receptacle, and the electrically conductive receptacle provides a second electrical contact to the light source.

18. An array of light source assemblies as claimed in claim 17, wherein the thickness of said receptacles is selected to provide sufficient conduction of heat generated by said light sources to maintain said light sources within a desired operating temperature range.
